(19) United States
(12) Patent Application Publication
(10) Pub. No.: US 2008/0084531 A1
(43) Pub. Date: Apr. 10, 2008

(54) EYEWEAR CLIP

(76) Inventor: Michael Pilarski, Romeo, MI (US)

Correspondence Address: Dickinson Wright PLLC, 38525 Woodward Avenue, Suite 2000, Bloomfield Hills, MI, 48304, US

(21) Appl. No.: 11/538,946

(22) Filed: Oct. 5, 2006

(51) Int. Cl. G02C 9/00

(52) U.S. Cl. 351/47

(57) ABSTRACT

A clip (12) for an eyewear device (22) is formed with a one-piece construction (34) with a pair of opposing end portions (36a, 36b) having clip fasteners. The clip fasteners including a visor clip fastener (38a) and an eyewear clip fastener (38b). The visor clip fastener (38a) is releasably attached to a visor (20) and defines a groove (40) receiving the same. The eyewear clip fastener (38b) is releasably attached to the eyewear device (22) and defines a notch (42) receiving the same. The groove (40) is substantially larger than the notch (42).

### TECHNICAL FIELD

The present invention relates generally to eyewear, and more particularly to a clip for holding eyewear in various positions as worn by an individual and/or stored in a vehicle.

### BACKGROUND

Conventional eyewear includes a nose bridge and a pair of ear pieces that support the eyewear on a person's nose and ears. It is understood that extended use of the eyewear can lead to soreness of the nose and ears. In addition, when the person perspires, such as when he participates in sports, the eyewear typically must be removed in order to wipe perspiration off the person's face or the sides of his head.

Sunglasses are commonly worn in passenger vehicles to reduce glare in foggy or hazy daylight conditions. The sunglasses typically are stored in a tray or storage compartment of the vehicle. In this regard, each time the driver uses the vehicle, the sunglasses typically are stored and retrieved from the compartment.

It is desirable to provide a clip for eyewear that is convenient to use and is formed with a simple construction having fewer parts and lower manufacturing costs, as compared with conventional eyewear.

### SUMMARY OF THE INVENTION

A clip for an eyewear device has a one-piece construction with a pair of opposing end portions having clip fasteners. The clip fasteners including a visor clip fastener and an eyewear clip fastener. The visor clip fastener is releasably attached to a visor and defines a notch receiving the same. The eyewear clip fastener is releasably attached to the eyewear device and defines a groove receiving the same. The notch is substantially larger than the groove.

One advantage of the invention is that a clip for eyewear is provided that improves the comfort of using the eyewear.

Another advantage of the invention is that a clip for eyewear is provided that has a simple construction formed from fewer parts as compared with conventional eyewear.

Yet another advantage of the invention is that a clip for eyewear is provided that can be readily stored and retrieved for use in vehicles.

Other advantages of the present invention will become apparent upon considering the following detailed description and appended claims, and upon reference to the accompanying drawings.

### BRIEF DESCRIPTION OF THE DRAWINGS

For a more complete understanding of this invention, reference should now be made to the embodiments illustrated in greater detail in the accompanying drawings and described below by way of the examples of the invention:

FIG. 1 is a perspective view of a hat and eyewear apparatus including an eyewear assembly with a clip, according to one embodiment of the invention;

FIG. 2 is an exploded view of the eyewear assembly shown in FIG. 1;

FIG. 3 is a cross-sectional view of the clip shown in FIG. 2, as taken along line 3-3; and

FIG. 4 is a forward view of a vehicle having a passenger cabin with an adjustable visor panel and the clip shown in FIG. 2, according to another embodiment of the claimed invention.

### DETAILED DESCRIPTION OF THE INVENTION

In the following figures, the same reference numerals are used to identify the same components in the various views.

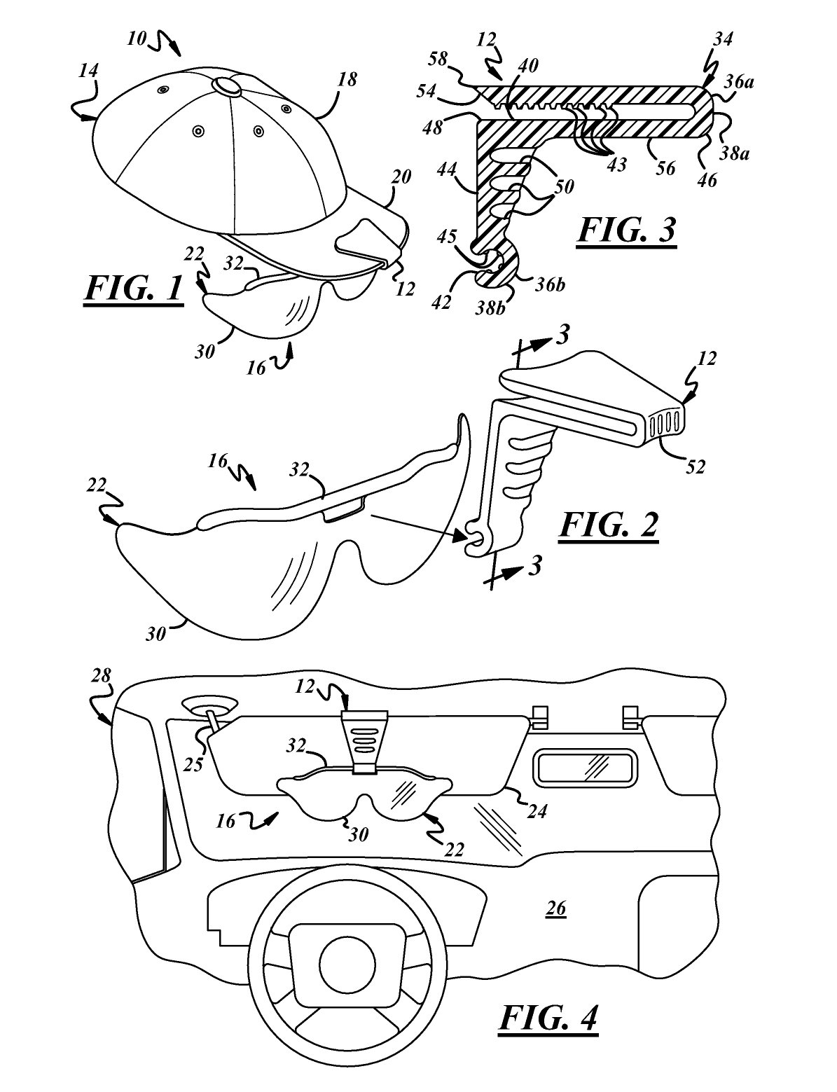

Referring to FIG. 1, there is shown a hat and eyewear apparatus 10 (“apparatus”) with a clip 12, according to one embodiment of the claimed invention. As detailed below, the clip 12 is beneficial for eliminating the discomfort of nose bridges and ear pieces that typically support conventional eyewear.

The apparatus 10 includes a hat 14 and an eyewear assembly 16. The hat 14 has a cap portion 18 and a visor 20. The eyewear assembly 16 includes the clip 12 and an eyewear device 22, which is attached to the visor 20 by the clip 12. However, it is contemplated that the eyewear assembly 16 can instead be attached to other suitable objects as desired. For instance, in the embodiment illustrated in FIG. 4, clip 12 attaches the eyewear device 22 to an adjustable visor panel 24 for a passenger cabin 26 of a vehicle 28.

As best shown in FIG. 2, eyewear device 22 consists of a wrap-around lens 30 and a bar member 32 extending from the lens 30. It will be appreciated that the bar member 32 can instead extend between two separate lenses as desired. The bar member 32 is attached to the clip 12. This eyewear device 22 does not include a nose bridge or ear pieces that typically form conventional eyewear. However, it is understood that the eyewear device 22 can include a nose bridge and ear pieces as desired. In this embodiment, the lens 30 has a UV coating and is polarized for reducing glare. It will be appreciated that the lenses 30 may be photochromic, mirrored, UV protected, polarized, tinted, otherwise treated, or any suitable combination thereof as desired.

With attention to FIG. 3, the clip 12 has a one-piece construction 34 with a pair of opposing end portions 36a, 36b respectively having a visor clip fastener 38a and an eyewear clip fastener 38b.

Visor clip fastener 38a is attached to the visor 20 of the hat 14 (shown in FIG. 1) and defines a groove 40 for receiving the same. In the illustrated embodiment, visor clip fastener 38a includes a series of protrusions 43 extending into groove 40 for gripping visor 20. It is understood that groove 40 can instead have a smoothly contoured surfaces along its length as desired.

Eyewear clip fastener 38b is attached to the eyewear device 22 and defines a notch 42 for receiving the same. Eyewear clip fastener 38b includes a series of resilient ribs 45 or other suitable projections extending into notch 42 for gripping bar member 32 of eyewear device 22. This feature can be beneficial for holding eyewear device in a variety of positions as desired. As shown in FIG. 3, groove 40 is sized substantially longer than notch 42. However, it is contemplated that groove 40 and notch 42 can have various sizes as styling dictates.

The clip 12 further includes a central body 44 extending between the opposing end portions 36a, 36b. In particular, visor clip fastener 38a includes a closed-ended portion 46 and an open-ended portion 48, with the central body 44 extending from open-ended portion 48.

The central body 44 is formed with a series of channels 50 for minimizing the overall weight of the clip 12. This feature is beneficial for enhancing the comfort of wearing the apparatus 10 and reducing manufacturing costs.

As illustrated in FIG. 2, the notch 42 has a curved lateral cross-section 52 that receives the curved visor 20 of the hat 14. However, it is contemplated that the notch 42 can have a variety of other suitable lateral cross-sections as desired.

As best shown in FIG. 3, the visor clip fastener 38a includes a top flange 54 and a bottom flange 56, which define the notch 42. The open-ended portion 48 of the top flange 54 has a tapered edge 58 so as to facilitate insertion of the visor 20 into the notch 42.

The one-piece construction 34 of the clip 12 is formed from a resilient material with the notch 42 and groove 40 sized sufficiently small for press-fitting respectively with the visor 20 and eyewear device 22. In the illustrated embodiment, the clip 12 is formed from an elastomer. However, it is understood that the clip 12 can be formed from various suitable resilient or rigid materials.

Referring now to FIG. 4, there is shown a vehicle 28 with a passenger cabin 26 having an adjustable visor panel 24 with the eyewear assembly 16, according to another embodiment of the claimed invention. In this embodiment, the adjustable visor panel 24 and eyewear device 22 can be moved to a variety of suitable positions for use by a driver. In particular, visor panel 24 can be pivoted on pole member 25, and eyewear device 22 can be pivoted within notch 42 of the clip 12. It is further contemplated that clip 12 can be attached to a variety of suitable portions of the visor 24.

While particular embodiments of the invention have been shown and described, it will be understood, of course, that the invention is not limited thereto since modifications may be made by those skilled in the art, particularly in light of the foregoing teachings. Accordingly, it is intended that the invention be limited only in terms of the appended claims.

What is claimed is:

1. A clip for an eyewear device, comprising:
a one-piece construction with a pair of opposing end portions;
one of said pair of opposing end portions having a visor clip fastener;
the other of said pair of opposing end portions having an eyewear clip fastener;
said visor clip fastener releasably attached to a visor;
said visor clip fastener defining a groove receiving said visor;
said eyewear clip fastener releasably attached to said eyewear device;
said eyewear clip fastener defining a notch receiving said eyewear device;
said groove substantially larger than said notch.

2. The clip recited in claim 1 wherein said one-piece construction includes a central body between said pair of opposing ends with a series of channels formed in said central body.

3. The clip recited in claim 2 wherein said groove in said visor clip fastener includes an open-ended portion and a closed-ended portion, with said central body extending from said open-ended portion.

4. The clip recited in claim 1 wherein said groove in said visor clip fastener has a curved lateral construction for receiving a curved visor.

5. The clip recited in claim 1 wherein said visor clip fastener includes a top flange and a bottom flange defining said groove with said top flange having a tapered edge.

6. An eyewear assembly, comprising:
said clip recited in claim 1; and
an eyewear device having a bar member releasably attached to said eyewear clip fastener of said clip.

7. A hat and eyewear apparatus, comprising:
a hat having a cap portion and a visor;
said eyewear assembly recited in claim 4 with said visor clip fastener releasably attached to said visor of said hat.

8. The hat and eyewear apparatus recited in claim 7 wherein said one-piece construction includes a central body between said pair of opposing ends with a series of channels formed in said central body.

9. The hat and eyewear apparatus recited in claim 7 wherein said groove in said visor clip fastener includes an open-ended portion and a closed-ended portion, with said central body extending from said open-ended portion adjacent to said cap portion of said hat.

10. The hat and eyewear apparatus recited in claim 9 wherein said visor clip fastener has a curved lateral construction receiving said visor.

11. A vehicle, comprising:
a passenger cabin;
an adjustable visor panel in said passenger cabin;
said eyewear assembly recited in claim 6 with said visor clip fastener releasably attached to said adjustable visor panel.

12. A clip for an eyewear device, comprising:
a resilient one-piece construction with a pair of opposing end portions;
one of said pair of opposing end portions having a visor clip fastener;
the other of said pair of opposing end portions having an eyewear clip fastener;
said visor clip fastener releasably attached to a visor;
said visor clip fastener defining a groove receiving said visor;
said eyewear clip fastener releasably attached to said eyewear device;
said eyewear clip fastener defining a notch receiving said eyewear device;
said groove substantially larger than said notch;
said eyewear clip fastener including a series of projections extending into said notch for holding said eyewear in at least one predetermined position.

13. The clip recited in claim 12 wherein said series of projections is a series of ribs.

14. The clip recited in claim 12 wherein said one-piece construction includes a central body between said pair of opposing ends, with a series of channels formed in said central body.

15. The clip recited in claim 12 wherein said notch in said visor clip fastener has a curved lateral construction for receiving a curved visor.

16. An eyewear assembly, comprising:
said clip recited in claim 12; and
an eyewear device having a bar member releasably attached to said clip within said notch of said eyewear clip fastener.

17. A clip for an eyewear device, comprising:
a resilient one-piece construction with a pair of opposing end portions having a pair of clamp members;
said pair of clamp members including a visor clamp and an eyewear clamp;
said visor clamp releasably attached to a visor;
said visor clamp defining a groove receiving said visor;
said eyewear clamp releasably attached to said eyewear device;
said eyewear clamp defining a notch receiving said eyewear device;
said groove substantially larger than said notch.

18. An eyewear assembly, comprising:
said clip recited in claim 17; and
an eyewear device releasably attached to said eyewear clamp of said clip;
said eyewear device consisting of at least one spectacle and a bar member;
said bar member releasably attached to said eyewear clamp within said notch.

19. The eyewear assembly recited in claim 18 wherein said at least one spectacle includes a pair of opposing end portions and a central portion with said bar member attached to said central portion.

20. A hat and eyewear apparatus, comprising:
a hat having a cap portion and a visor;
said eyewear assembly recited in claim 18 with said visor clamp releasably attached to said visor of said hat.
